(19) United States
(12) Patent Application Publication
(10) Pub. No.: US 2026/0078617 A1
(43) Pub. Date: Mar. 19, 2026

(54) MOTOR VEHICLE LOCK FOR A LOCKING ELEMENT OF A MOTOR VEHICLE

(71) Applicant: Brose Schließsysteme GmbH & Co. Kommanditgesellschaft, Wuppertal (DE)

(72) Inventors: Ludger GRAUTE, Essen (DE); Mi YIZHOU, Velbert (DE); M. Manoj KRISHNA, Tirunelveli (IN); Tejas PATIL, Pune (IN); Avinash IRLAPALLE, Pune (IN)

(21) Appl. No.: 19/331,505

(22) Filed: Sep. 17, 2025

(30) Foreign Application Priority Data
Sep. 17, 2024 (DE) 102024126770.4

(51) Int. Cl. E05B 81/46; E05B 81/04; E05B 81/16; E05B 81/34; E05B 81/80

(52) U.S. Cl. CPC E05B 81/46; E05B 81/04; E05B 81/16; E05B 81/34; E05B 81/80

(57) ABSTRACT

A motor vehicle lock with a lock latch and a pawl, a release lever being provided that can be pivoted from a starting position to a release position during an opening movement with a release direction, the release lever lifting the pawl with the opening movement, an electric opening drive being provided, by means of which the release lever can be pivoted to carry out the opening movement, so that the opening drive lifts the pawl by means of the release lever in a motorized manner, an actuator lever being provided that can be manually pivoted in an actuation stroke from an unactuated position to an actuated position, and by means of which the release lever located in the starting position can be pivoted with the actuation stroke to carry out the opening movement, so that the actuator lever manually lifts the pawl by means of the release lever.

### CROSS-REFERENCE TO RELATED APPLICATION

This application claims priority pursuant to 35 U.S.C. 119(a) to German Application No. 102024126770.4, filed Sep. 17, 2024, which application is incorporated herein by reference in its entirety.

### FIELD OF THE INVENTION

The present invention relates to a motor vehicle lock according to the preamble of Claim 1.

### BACKGROUND

The motor vehicle lock in question is used for all types of locking elements of a motor vehicle. These include locking elements such as side doors, rear doors, tailgates, trunk lids, hoods, and the like. These locking elements can generally be designed as swing or sliding doors.

The known prior art (DE 10 2017 105 834 A1), on which the invention is based, relates to a motor vehicle lock that has a lock latch and a pawl as locking elements. The lock latch can be brought into a locking position in which it is in holding engagement with a locking part and in which it is fixed by the pawl. The motor vehicle lock is designed as an electric lock and has an opening drive with an electric drive motor with which the pawl can be lifted so that the lock latch can be adjusted to its open position, releasing the locking part.

In an electric lock, locking states, which in mechanical door locks are implemented by means of lever arrangements, can be replaced by switching functions of an electronic control arrangement, by means of which the electric drive motor is controlled or not controlled for an electric opening process. This can result in increased ease of use.

The known motor vehicle lock (DE 10 2017 105 834 A1) is additionally designed with a mechanical redundancy for lifting the pawl. For example, if the electrical power supply to the drive motor fails, the pawl can be lifted using a door handle in a manual opening process. For this purpose, the actuator lever of the motor vehicle lock is mechanically connected to the door handle, whereby the pawl can be lifted via the actuator lever.

A challenge is that, when a mechanical redundancy is provided to implement locking states intended to prevent manual lifting via the door handle, the mechanical actuation must in turn be rendered ineffective. For this reason, electric locks also sometimes make use of the lever arrangements mentioned, which, for example, allow for decoupling via a switchable coupling element. However, this increases the mechanical complexity of the motor vehicle lock, even in electric locks.

### SUMMARY

The invention relates to a motor vehicle lock with a lock latch and a pawl, a release lever being provided that can be pivoted from a starting position to a release position during an opening movement with a release direction, the release lever lifting the pawl with the opening movement, an electric opening drive being provided, by means of which the release lever can be pivoted to carry out the opening movement, so that the opening drive lifts the pawl by means of the release lever in a motorized manner, an actuator lever being provided that can be manually pivoted in an actuation stroke from an unactuated position to an actuated position, and by means of which the release lever located in the starting position can be pivoted with the actuation stroke to carry out the opening movement, so that the actuator lever manually lifts the pawl by means of the release lever. It is proposed that the release lever can be pivoted by means of the opening drive from the starting position to an idle stroke position counter to the release direction, and that the actuation stroke of the actuator lever is an idle stroke with respect to the release lever when the release lever is in the idle stroke position.

The invention is based on the problem of designing and developing the known motor vehicle lock in such a way that mechanical redundancy is implemented with a simple construction.

The above problem is solved by the features of Claim 1.

The invention is based on providing a release lever that is used both by the opening drive for motorized lifting and by the actuator lever for manual lifting of the pawl. To this end, the release lever can be pivoted from a starting position during an opening movement with a release direction.

The fundamental consideration is that the opening drive can further be used to pivot the release lever out of the effective range of the actuator lever, thus easily preventing manual actuation by the actuator lever. Accordingly, locking states such as “locked,” “child-safe” and/or “theft-protected” can also be implemented mechanically without the need for additional coupling elements or the like.

It is proposed that the release lever can be pivoted by means of the opening drive from the starting position to an idle stroke position counter to the release direction, and that the actuation stroke of the actuator lever is an idle stroke with respect to the release lever when the release lever is in the idle stroke position.

A particularly simple implementation of the idle stroke position is specified in Claim 2, in which a release element of the release lever is removed from the range of movement of the actuator lever.

Particularly preferred is the embodiment in accordance with Claims 3 and 4, according to which a freewheel pawl is provided that allows the actuator lever to be returned from its actuated position when the release lever is outside the idle stroke position. This ensures that the actuator lever does not jam even if manual and motorized actuations occur at the same time.

By means of an angular arrangement of the actuator lever and the release lever in accordance with Claim 5, a compact construction of the motor vehicle lock can be achieved while at the same time allowing simple implementation of the idle stroke position.

A particularly operationally reliable determination of the starting position in which the actuator lever is effective with respect to lifting the pawl is preferably achieved by means of a sensor-based detection in accordance with Claim 6.

Preferred embodiments of the motor vehicle lock in accordance with Claims 7 to 11 relate to the mode of operation of the release lever and the pawl. The release lever can, among other things, have a dual function: in addition to lifting the pawl, it can also lock the pawl in the catching state.

Claim 12 further specifies a control arrangement that takes over actuation of the opening drive. Preferably, upon entry into an emergency mode, for example in the event of a crash, the control arrangement ensures that the release lever is adjusted to the starting position to provide mechanical redundancy.

### BRIEF DESCRIPTION OF THE DRAWINGS

In the following, the invention is explained in more detail with reference to a drawing that merely represents exemplary embodiments.

In the drawings:

FIG. 1a shows a motor vehicle door with a motor vehicle lock according to the proposal in a perspective view;

FIG. 1b shows a motor vehicle door with a motor vehicle lock according to the proposal in a perspective view;

FIG. 2a shows the motor vehicle lock in a side view with the release lever in the starting position according to the proposal;

FIG. 2b shows the motor vehicle lock in a side view with the release lever in the starting position according to the proposal;

FIG. 2c shows the motor vehicle lock in a side view during motorized lifting of the pawl according to the proposal;

FIG. 2d shows the motor vehicle lock in a side view during manual lifting of the pawl according to the proposal;

FIG. 3a shows the motor vehicle lock in a side view with the release lever in the idle stroke position according to the proposal;

FIG. 3b shows the motor vehicle lock in a side view with the release lever in the idle stroke position according to the proposal;

FIG. 3c shows the motor vehicle lock in a side view during a resetting of the actuator lever;

FIG. 3d shows the motor vehicle lock in a side view during a resetting of the actuator lever according to the proposal;

FIG. 4a shows a side view of the actuator lever during a resetting according to the proposal; and

FIG. 4b shows a side view of the actuator lever during a resetting according to the proposal.

### DETAILED DESCRIPTION OF THE INVENTION

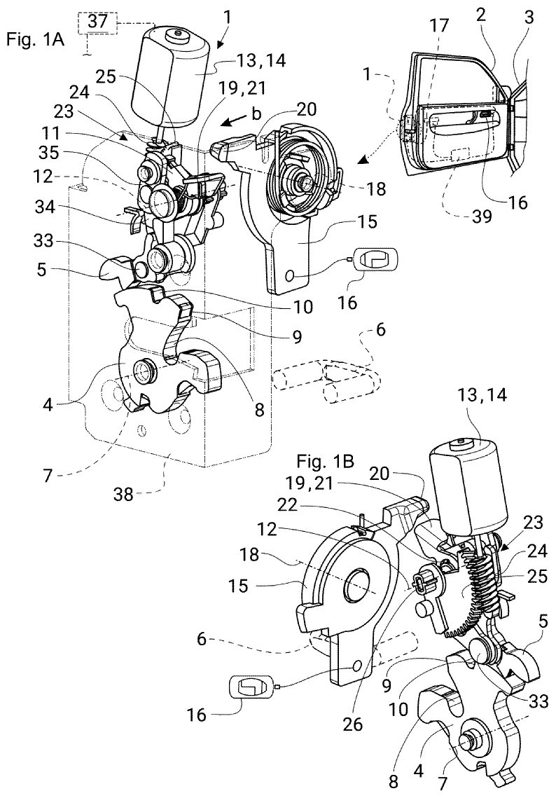

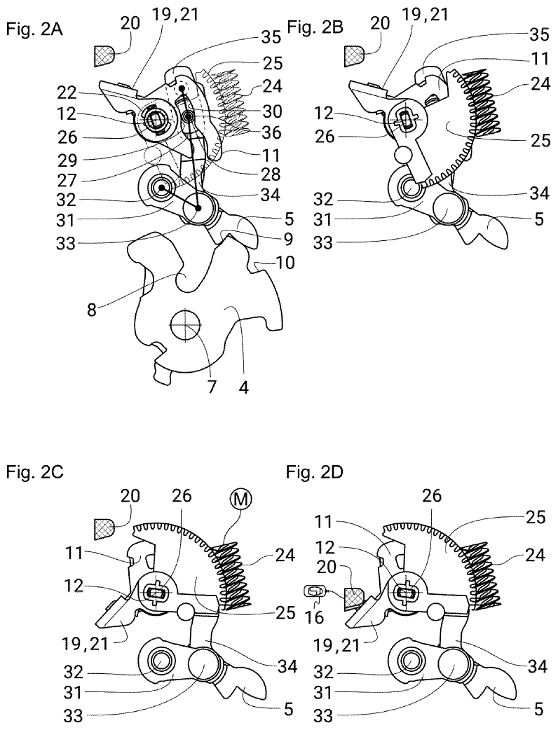

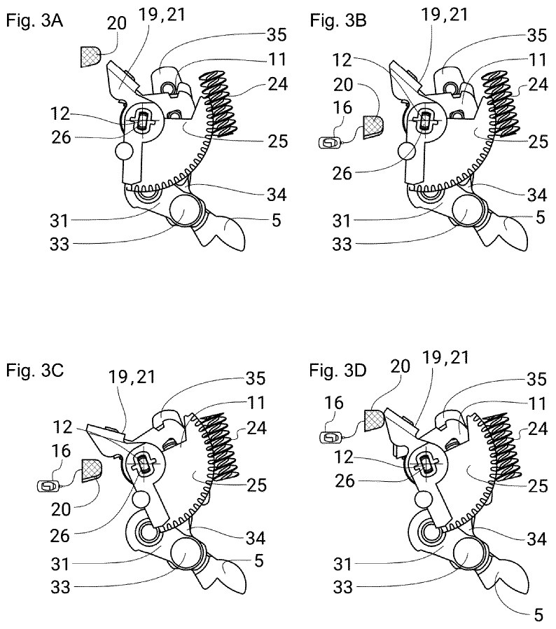

The exemplary embodiment shown in the figures and preferred in this respect relates to a motor vehicle lock 1 for a locking element 2 of a motor vehicle 3. With regard to the design of the locking element 2, reference may be made to the introductory statements, wherein in the present case FIGS. 1a and 1b show the mode of operation of the motor vehicle lock 1 for a locking element 2 designed as a side door. However, all statements also apply to all other types of locking elements of the motor vehicle 3. FIGS. 2 and 3 show the motor vehicle lock 1 in respective side views in different states to be explained below, wherein not all of the components of the motor vehicle lock 1 shown in FIGS. 1a and 1b are shown.

The motor vehicle lock 1 is equipped with a lock latch 4 and a pawl 5. The lock latch 4 is adjustable to at least one locking position, in this embodiment, and preferably a main locking position (FIG. 2a)), and optionally a pre-locking position, for holding engagement with a locking part 6, and to an open position (FIG. 1a), 1b)) for releasing the locking part 6, here preferably by pivoting about a geometric lock latch axis 7. The locking part 6 may be a locking bracket, a locking bolt, or the like. As can be seen in FIGS. 1a and 1b, when the lock latch 4 is in the open position, the locking part 6 can be inserted into a locking part receptacle 8 of the lock latch 4. In this embodiment, and preferably, the motor vehicle lock 1 is arranged on the locking element 2, while the locking part 6 is arranged fixed to the body of the motor vehicle 3, wherein a reverse arrangement is conceivable.

The pawl 5 interacting with the lock latch 4 can be brought into a catching state (FIG. 2a)) and a lifting state (FIGS. 1a), 1b), 2c), 2d)). In the catching state, the pawl 5 locks the lock latch 4 in the locking position against being adjusted in its opening direction. The locking positions can be reached starting from the open position in FIG. 1a) by pivoting the lock latch 4 counter-clockwise, whereby the pawl 5 can reach a main catch 9 (main locking position; FIG. 2a)) or pre-catch 10 (pre-locking position; not shown) of the lock latch 4 by catching in a locking engagement. In the lifting state, the pawl 5 releases the lock latch 4 in its opening direction, so that the lock latch 4 can be transferred to the open position, for example, by spring loading and/or by guiding out the locking part 6.

A release lever 11 is provided, which generally serves to transfer the pawl 5 into the lifting state. The release lever 11 can be seen in more detail in FIG. 2a) and is shown partially hidden in the other figures. The release lever 11 can be pivoted from a starting position (FIGS. 2a), 2b), 3c), 3d)) to a release position (FIGS. 2c), 2d)) about a geometric release lever axis 12. The pivoting from the starting position to the release position occurs during an opening movement with a release direction, the release direction corresponding to the pivoting direction of the release lever 11 in the opening movement. In FIGS. 2 and 3, the release direction corresponds to the pivoting of the release lever 11 about the release lever axis 12 in a counter-clockwise direction. The opening movement of the release lever 11 causes the release lever 11 to lift the pawl 5.

The release lever 11 can transfer the pawl 5 to the lifting state by direct mechanical contact. In this case, and preferably, the transfer of the pawl 5 by the release lever 11 is effected indirectly by means of at least one further element. The preferred mode of operation of indirect lifting shown in the figures is explained below.

An electric opening drive 13 is provided, by means of which the release lever 11 can be pivoted to carry out the opening movement, so that the opening drive 13 lifts the pawl 5 by means of the release lever 11. For example, a door handle of the locking element 2 is equipped with a sensor such as a push-button, whereby actuation of the door handle is detected. The opening drive 13 can then be actuated to cause the pawl 5 to be lifted by a motor. The motorized lifting of the pawl 5 can be seen from the sequence in the illustrations in FIGS. 2b) and 2c), in this case a driving force of a drive motor 14 of the opening drive 13 moving the release lever 11 to the release position.

An actuator lever 15 is provided for coupling with an operating element such as a door handle and serves for the manual actuation of the motor vehicle lock 1. In the assembled state of the motor vehicle lock 1, the actuator lever 15 is mechanically connected, for example, to an interior door handle 16, to an exterior door handle 17 and/or to an emergency actuating element via a connecting element, such as a Bowden cable or a rod. An actuation force exerted manually on the operating element can be transmitted to the actuator lever 15, whereby the actuator lever 15 executes an actuation stroke. The actuator lever 15 can be manually pivoted about a geometric actuator lever axis 18 from an unactuated position to an actuated position during the actuation stroke. By means of the actuator lever 15, the release lever 11, which is in the starting position, can be pivoted with the actuation stroke to carry out the opening movement, so that the actuator lever 15 manually lifts the pawl 5 by means of the release lever 11. The manual lifting of the pawl 5 can be seen from the sequence in the illustrations in FIGS. 2b) and 2d), in this case a manual pivoting of the actuator lever 15 moving the release lever 11 to the release position.

Both the motorized lifting and the manual lifting are therefore carried out via the release lever 11, which serves to transmit the actuation force to the pawl 5.

It is now important that the release lever 11 can be pivoted by means of the opening drive 13 from the starting position to an idle stroke position counter to the release direction, and that the actuation stroke of the actuator lever 15 is an idle stroke with respect to the release lever 11 when the release lever 11 is in the idle stroke position.

In addition to the motorized lifting of the pawl 5 via the release lever 11, the opening drive 13 performs the additional function of pivoting the release lever 11 into the idle stroke position (FIGS. 3a), 3b)), which can be achieved in particular by operating the drive motor 14 in the drive direction counter to the motorized lifting. In the idle stroke position, the actuation stroke of the actuator lever 15 is an idle stroke with respect to the release lever 11, so that manual lifting via the actuator lever 15 is then not possible. If the actuator lever 15 is provided for interior actuation, a child-safe and/or theft-protected locking state can be achieved via the idle stroke position.

What is particularly interesting about the proposed solution is that additional lever arrangements with coupling elements or the like are not necessary to deactivate the actuator lever 15. The opening drive 13, which is in any case provided for motorized lifting, is designed to adjust the release lever 11 so that manual lifting via the actuator lever 15 is prevented.

It is preferably provided that the release lever 11 has a release element 19 that, in the starting position, projects into a range of movement of the actuator lever 15 and can be carried along with the actuation stroke by means of the actuator lever 15. By being carried along, a force is transmitted from the actuator lever 15 to the release element 19 during the actuation stroke, whereby the release lever 11 is pivoted into the release position (FIG. 2d)).

In the idle stroke position, the release element 19 is outside the range of movement. The release lever 11 is pivoted via the opening drive 13 so that the actuator lever 15 runs past the release element 19 with the actuation stroke (FIG. 3b)). Accordingly, no force is transmitted from the actuator lever 15 to the release lever 11, which in this case remains in the idle stroke position.

In this case, and preferably, the actuator lever 15 has an actuating element 20 that, when the release lever 11 is in the starting position, can be brought into contact with the release element 19 to pivot the release lever 11. In the idle stroke position, however, the actuating element 20 runs past the release element 19 with the actuation stroke.

Particularly preferably, a freewheel pawl 21 is provided between the actuator lever 15 and the release lever 11, by means of which the release lever 11 can be pivoted in the release direction by means of the actuator lever 15. The freewheel pawl 21 can be pivotally associated with the release lever 11 or the actuator lever 15 by means of a freewheel 22.

Preferably, the freewheel pawl 21, as shown in FIGS. 2 and 3, is pivotally coupled to the release lever 11 and preferably forms the release element 19. With the actuation stroke, the actuator lever 15 is brought into contact with the freewheel pawl 21 when the release lever 11 is in the starting position (FIG. 2d)). The freewheel pawl 21 is furthermore coupled to the release lever 11 via a freewheel 22, which can be seen in more detail in FIG. 2a), the release lever 11 being carried along by mechanical contact with the freewheel pawl 21 during the actuation stroke.

The freewheel pawl 21 allows the actuator lever 15 to be returned from the actuated position to the unactuated position when the release lever 11 is outside the idle stroke position, which is further shown in FIGS. 3c) and 3d). If, for example, in the presence of the idle stroke from FIG. 3b) and with the actuator lever 15 in the actuated position, the release lever 11 is pivoted by means of the opening drive 13 from the idle stroke position into the starting position, the state from FIG. 3c) may arise. If the actuator lever 15 is then released, for example by releasing the door handle, the actuator lever 15 can again attain the unactuated position without jamming, because the freewheel 22 allows the freewheel pawl 21 to pivot in this direction by means of the actuator lever 15, which is shown in FIG. 3d). After the actuator lever 15 has passed, the state from FIG. 2b) can again be assumed, the freewheel pawl 21 returning under spring preload.

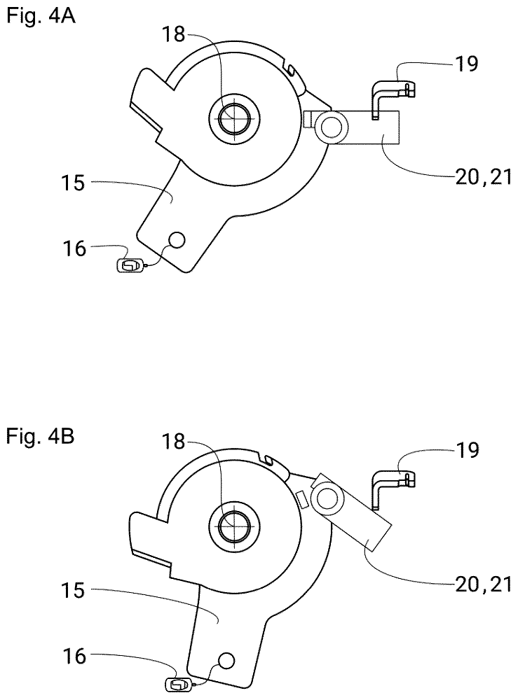

In an alternative embodiment, it is provided that the freewheel pawl 21 is pivotally coupled to the actuator lever 15 with a freewheel 22 and forms the actuating element 20, which is shown in FIG. 4. In this illustration, the actuation stroke corresponds to a pivoting of the actuator lever 15 in a clockwise direction, whereby the release lever 11 is carried along via the freewheel pawl 21 (not shown). If the release lever 11 is outside the idle stroke position, the actuator lever 15 can be returned from the actuated position (FIG. 4a)) to the unactuated position via the freewheel 22 of the freewheel pawl 21 by pivoting the freewheel pawl 21 (FIG. 4b)). Here too, the freewheel pawl 21 can fall back under spring preload.

It is particularly preferred that a pivoting plane of the release lever 11 is aligned at an angle to a pivoting plane of the actuator lever 15. The pivoting plane of the release lever 11 is a plane perpendicular to the release lever axis 12 in which the release lever 11 is located. The pivoting plane of the actuator lever 15 is a plane perpendicular to the actuator lever axis 18 in which the actuator lever 15 is located. The angle between the planes is preferably more than 45°. In particular, a perpendicular alignment of the planes is provided, which is shown by way of example in FIGS. 1a and 1b.

Furthermore, it is preferably provided here that a position sensor is provided for the opening drive 13, which position sensor detects the attainment of the starting position of the release lever 11. The position sensor can be associated with the release lever 11 or with an element coupled to the release lever 11. The position sensor is implemented, for example, by means of a Hall sensor, microswitch, reed switch, angle sensor or the like and can ensure that the release lever 11 reliably attains its starting position via sensor-based actuation of the opening drive 13.

The idle stroke position and/or the release position can also be detected by a sensor. In this case, and preferably, however, mechanical end stops are provided for the idle stroke position and/or the release position, whereby these positions can be detected, for example, by detecting a stall current of the drive motor 14.

It is also conceivable that a mechanical latching element is provided for the release lever 11, which latching element releasably latches the release lever 11 in the starting position by means of the opening drive 13 or the actuator lever 15. “Releasable latching” means that the release lever 11 can be moved out of the starting position against the latching force of the release lever 11 by means of the opening drive 13 or the actuator lever 15. However, the latching force stabilizes the release lever 11 in the starting position. The latching element can be implemented, for example, via a spring lip or the like, which is inserted into a latching recess.

Furthermore, it is preferably provided here that the release lever 11 is coupled in a rotationally fixed manner to a gear element 23 of a gear 23 of the opening drive 13. The gear 23 preferably provides a gear ratio converting a rotational output movement of the drive motor 14 into an output movement of the gear 23, which is here delivered to the release lever 11 via the rotationally fixed connection. The gear 23 can be single-stage or multi-stage. Preferably, the gear 23 is designed to be non-self-locking, so that the release lever 11 can be moved via the actuator lever 15 while the drive motor 14 is back-driven.

In this case, and preferably, the gear 23 is designed as a worm gear, in which a worm 24 associated with a drive motor 14 of the gear 23 is in meshing engagement with a toothing of a toothed element 25, the release lever 11 being coupled to the toothed element 25 in a rotationally fixed manner. For a more complete representation of the release lever 11, the toothed element 25 is drawn with dashed lines in FIG. 2a) and with solid lines in the other figures. The rotationally fixed connection is made here via a common shaft 26 of the toothed element 25 and the release lever 11.

Furthermore, it is preferably provided here that the release lever 11 has a pressing contour 27 that guides a coupling arrangement 28 associated with the pawl 5 to lift the pawl 5 with the opening movement. The pressing contour 27 is designed in a manner different from a concentric course relative to the release lever axis 12 (FIG. 2a)), so that the coupling arrangement 28 is moved over the guide with the opening movement. The coupling arrangement 28 transfers the pawl 5 to the lifting state and can be coupled directly or indirectly to the pawl 5.

The pressing contour 27 is followed by a freewheel contour 29 that, when pivoted into the idle stroke position, guides the coupling arrangement 28 while the pawl 5 remains in the catching state. The freewheel contour 29 is in this case, and preferably, formed concentrically about the release lever axis 12. When the release lever 11 is pivoted into the idle stroke position, the guidance preferably causes no movement of the coupling arrangement 28, so that the pawl 5 remains in the catching state. The pressing contour 27 and the freewheel contour 29 are in this case, and preferably, formed by a recess in the release lever 11 into which the coupling arrangement 28 projects. The continuation of the recess with the freewheel contour 29 allows the release lever 11 to be pivoted into the idle stroke position without moving the coupling arrangement 28.

Furthermore, it is preferably provided here that the release lever 11 has a locking contour 30 that, in the starting position, blocks a transfer of the pawl 5 into the lifting state and, with the opening movement, releases the transfer of the pawl 5 into the lifting state. The release lever 11 locks the pawl 5 in the starting position (FIG. 2a)) and in this case, and preferably, in the idle stroke position, so that the pawl 5 remains in the catching state. The locking can be effected by an indirect interaction, in this case via the coupling arrangement 28, locking via direct mechanical contact with the pawl 5 also being conceivable.

In the illustrated embodiment, which is preferred in this respect, the locking contour 30 is formed by the recess in the release lever 11, which recess also forms the aforementioned pressing contour 27 and in particular the freewheel contour 29 (FIG. 2a)).

Furthermore, it is preferably provided here that the pawl 5 is mounted pivotally on a pivotable pawl lever 31 that can be brought by means of the release lever 11 from a normal position (FIGS. 1, 2a), 2b), 3), in which the pawl 5 can be transferred to the catching state, to a deflected position (FIGS. 2b), 2c)), in which the pawl 5 is transferred to the lifted state. The pawl lever 31 is designed to be pivotable about a geometric pawl lever axis 32.

Preferably, the pawl lever 31 and the pawl 5 form a toggle lever arrangement. The pivotable mounting of the pawl 5 on the pawl lever 31 represents the first toggle joint 33 of the toggle joint arrangement. The release lever 11 causes the toggle joint arrangement to bend with the opening movement, thereby moving the pawl 5 into the lifted state.

The release lever 11 or an intermediate lever 34 adjusted by means of the release lever 11, which in this case interacts with the coupling arrangement 28, preferably engages the toggle joint of the toggle lever arrangement during the opening movement. In this case, the intermediate lever 34 can form a second toggle lever arrangement with a pivotally mounted coupling lever 35, which bends as the opening movement occurs. In this embodiment, the coupling lever 35 and the intermediate lever 34 are connected to one another via a second toggle joint 36, the coupling arrangement 28 preferably being arranged on the second toggle joint 36.

Furthermore, a control arrangement 37 for controlling the opening drive 13 can be provided as part of the motor vehicle lock 1. The control arrangement 37 is preferably integrated in a lock housing 38, which is merely indicated in FIG. 1. In principle, the control arrangement 37 can perform the control-related tasks associated with actuating the opening drive 13.

Here and preferably, locking states such as “unlocked,” “centrally locked,” “theft-protected,” “child-safe” are stored in a memory of the control arrangement 37. Based on the current locking state, it can be decided whether the drive motor 14 should be actuated to carry out the electrical opening process in response to an actuation signal. These locking states can primarily relate to the electrical opening process. Upon entry into at least one predetermined locking state, the control arrangement 37 can control the opening drive 13 to bring the release lever 11 into the idle stroke position. When the locking state “theft-protected” and/or “child-safe” is entered, manual interior actuation via the actuator lever 15 is prevented in this way. In particular, when the locking state “unlocked” and/or “child safety lock off” is entered, the opening drive 13 is controlled by means of the control arrangement 37 to adjust the release lever 11 from the idle stroke position to the starting position, so that manual actuation via the actuator lever 15 is possible.

When an emergency mode is entered, the control arrangement 37 can control the opening drive 13 to adjust the release lever 11 from the idle stroke position to the starting position. The emergency mode is provided for situations in which the supply voltage may not be sufficient to control the opening drive 13. Examples of this include failure of an on-board electrical system, for example due to a largely discharged central battery or electrical cable failure in the on-board electrical system, and in the event of a crash of the motor vehicle 3. Mechanical redundancy is provided by the adjustment to the starting position. In particular in the event of a crash, a time delay can be provided between the entry into an emergency mode, for example upon receipt of a crash signal by means of the control arrangement 37, and the adjustment to the starting position, so as to avoid crash-induced lifting of the pawl 5 caused by inertial forces acting on the actuator lever 15.

The actuation with regard to an emergency mode can be carried out based on an energy supply from an electrical energy store of the control arrangement 37. For example, the control arrangement 37 is equipped with at least one capacitor, such as at least one double-layer capacitor, and/or with a primary cell, whereby a power supply to the opening drive 13 can be ensured.

In addition to or instead of the aforementioned embodiment with a control arrangement 37 integrated into the motor vehicle lock 1, it is conceivable that the control arrangement 37 is part of a separate control unit 39 for the motor vehicle lock 1. Examples of such a control unit 39 are a flap control unit and a door control unit, which can also perform further electronic functions in the locking element 2.

1. A motor vehicle lock having a lock latch and at least one a pawl, it being possible to adjust the lock latch to at least one locking position for the holding engagement with a locking part and to an open position for releasing the locking part, the pawl, in a catching state, locking the lock latch located in the locking position against moving in its opening direction and releasing it in a lifting state,
a release lever being provided that can be pivoted from a starting position to a release position during an opening movement with a release direction, the release lever lifting the pawl with the opening movement,
an electric opening drive being provided, by means of which the release lever can be pivoted to carry out the opening movement, so that the opening drive lifts the pawl by means of the release lever,
an actuator lever being provided that can be manually pivoted in an actuation stroke from an unactuated position to an actuated position, and by means of which the release lever located in the starting position can be pivoted with the actuation stroke to carry out the opening movement, so that the actuator lever manually lifts the pawl by means of the release lever, wherein the release lever can be pivoted by means of the opening drive from the starting position to an idle stroke position counter to the release direction, and in that the actuation stroke of the actuator lever is an idle stroke with respect to the release lever when the release lever is in the idle stroke position.

2. The motor vehicle lock according to claim 1, wherein the release lever has a release element that, in the starting position, projects into a range of movement of the actuator lever and can be carried along with the actuation stroke by means of the actuator lever, and that, in the idle stroke position, is located outside the range of movement.

3. The motor vehicle lock according to claim 1, wherein a freewheel pawl is provided between the actuator lever and the release lever, by means of which freewheel pawl the release lever can be pivoted in the release direction by means of the actuator lever, and which freewheel pawl allows the actuator lever to be returned from the actuated position to the unactuated position when the release lever is outside the idle stroke position.

4. The motor vehicle lock according to claim 3, wherein the freewheel pawl is pivotally associated with the release lever or with the actuator lever via a freewheel.

5. The motor vehicle lock according to claim 1, wherein a pivoting plane of the release lever is aligned at an angle, preferably perpendicularly, to a pivoting plane of the actuator lever.

6. The motor vehicle lock according to claim 1, wherein a position sensor is provided for the opening drive, which position sensor detects the attainment of the starting position of the release lever, and/or in that a mechanical latching element is provided for the release lever, which latching element releasably latches the release lever in the starting position by means of the opening drive or the actuator lever.

7. The motor vehicle lock according to claim 1, wherein the release lever is coupled in a rotationally fixed manner to a gear element of a gear of the opening drive, preferably in that the gear is designed as a worm gear mechanism in which a worm associated with a drive motor of the gear is in meshing engagement with a toothing of a toothed element, and in that the release lever is coupled in a rotationally fixed manner to the toothed element.

8. The motor vehicle lock according to claim 1, wherein the release lever has a pressing contour that guides a coupling arrangement associated with the pawl with the opening movement for lifting the pawl, and in that a freewheel contour adjoins the pressing contour, which pressing contour, upon pivoting into the idle stroke position, guides the coupling arrangement while the pawl remains in the catching state.

9. The motor vehicle lock according to claim 1, wherein the release lever has a locking contour that, in the starting position, blocks a transfer of the pawl into the lifting state and, with the opening movement, releases the transfer of the pawl into the lifting state.

10. The motor vehicle lock according to claim 1, wherein the pawl is mounted pivotally on a pivotable pawl lever that can be brought by means of the release lever from a normal position, in which the pawl can be transferred to the catching state, to a deflected position, in which the pawl is transferred to the lifting state.

11. The motor vehicle lock according to claim 10, wherein the pawl lever and the pawl form a toggle lever arrangement and in that the release lever causes the toggle joint arrangement to bend with the opening movement, thereby moving the pawl into the lifting state, preferably in that the release lever or an intermediate lever adjusted by means of the release lever acts on a toggle joint of the toggle lever arrangement in the opening movement, further preferably in that the intermediate lever forms a second toggle lever arrangement that bends with the opening movement.

12. The motor vehicle lock according to claim 1, wherein a control arrangement for controlling the opening drive is provided, preferably in that the control arrangement, upon entry into an emergency mode, in particular on the basis of an energy supply from an electrical energy store of the control arrangement, actuates the opening drive to adjust the release lever from the idle stroke position to the starting position.

13. The motor vehicle lock according to claim 2, wherein a freewheel pawl is provided between the actuator lever and the release lever, by means of which freewheel pawl the release lever can be pivoted in the release direction by means of the actuator lever, and which freewheel pawl allows the actuator lever to be returned from the actuated position to the unactuated position when the release lever is outside the idle stroke position.

14. The motor vehicle lock according to claim 2, wherein a pivoting plane of the release lever is aligned at an angle, preferably perpendicularly, to a pivoting plane of the actuator lever.

15. The motor vehicle lock according to claim 3, wherein a pivoting plane of the release lever is aligned at an angle, preferably perpendicularly, to a pivoting plane of the actuator lever.

16. The motor vehicle lock according to claim 4, wherein a pivoting plane of the release lever is aligned at an angle, preferably perpendicularly, to a pivoting plane of the actuator lever.
